(19) United States
(12) Patent Application Publication
(10) Pub. No.: US 2020/0134667 A1
(43) Pub. Date: Apr. 30, 2020

(54) DYNAMIC CAMPAIGNS IN VIRTUAL REALITY ENVIRONMENT

(71) Applicant: VDRoom Ltd., Petach-Tikva (IL)

(72) Inventors: Lance BAILEY, Ramat Gan (IL); Michal HUBSCHMANN RAHAMIM, Kfar-Saba (IL)

(73) Assignee: VDRoom Ltd., Petach-Tikva (IL)

(21) Appl. No.: 16/175,902

(22) Filed: Oct. 31, 2018

(51) Int. Cl. G06Q 30/02; G06F 3/0481

(52) U.S. Cl. CPC G06Q 30/0257; G06F 3/012; G06F 3/04815; G06Q 30/0239

(57) ABSTRACT

A method of dynamically expanding an online advertisement campaign in a VR environment comprising: receiving an advertisement request from a website loaded by a client device for VR presentation a VR environment on a VR display to a user using a VR user interface to navigate in the VR presentation, the advertisement request comprises a request to present an advertisement items to the user currently presented with at least a portion of a certain page of the website, selecting a presentation location in the page for embedding a presentation symbol correlated with a selected advertisement item and responding to the advertisement request with an instruction to embed the presentation symbol in the presentation location. Wherein the presentation location is selected to be discoverable by the user according to a discovery difficulty level calculated based on campaign parameter(s) defined by campaign rule(s) extracted from a campaign policy associated with the website.

### FIELD AND BACKGROUND OF THE INVENTION

The present invention, in some embodiments thereof, relates to dynamically expanding an online advertisement campaign in a virtual reality (VR) environment, and, more specifically, but not exclusively, to dynamically expanding an online advertisement campaign in a VR environment based on gamification of advertisement items discovery.

Online advertising has become a major channel for delivering promotional marketing messages to consumers. The online advertising may be highly efficient for a plurality of advertisement campaigns compared to the traditional advertising channel such as posting advertisements on television, cinema, newspapers and/or the like. One or the main forms of online adverting is directed to embed advertisements in online content consumed and viewed by the consumers while browsing websites and/or using mobile applications.

Virtual Reality, such as VR, Augmented Reality (AR), X Reality (XR), VR 360, layered reality and/or the like has been rapidly evolving in recent times. VR technology, systems and applications are widely spreading and may target various, diverse needs, applications, markets and/or the like, ranging from medical procedures training and practice applications through industry/military training applications to trading, shopping, leisure and gaming applications.

Due to its inherent advantages, the VR technology may be a realistic, efficient and hence highly appealing platform for interacting with human users. Presenting the user with a visual presentation, either realistic, synthetic and/or a combination thereof, optionally coupled with an audible, tactile and/or other sensory simulation, may allow realistically simulating a plurality of diverse scenes, scenarios, events, situations, cases, conditions and/or the like for the users. To maintain an effective simulation, user input may be captured using wearable VR sensors, for example, inertial sensors that may capture movement, motion, gestures and/or the like initiated by the user.

### SUMMARY OF THE INVENTION

According to a first aspect of the present invention there is provided a computer implemented method of dynamically expanding an online advertisement campaign in a virtual reality (VR) environment, comprising using one or more processors of a campaign management system for:
Receiving an advertisement request from a website loaded by a client device for VR presentation a VR environment on a VR display to a user using a VR user interface to navigate in the VR presentation. The advertisement request comprises a request to present an advertisement items to the user currently presented with at least a portion of a certain page of the website.
Selecting a presentation location in the certain page for embedding a presentation symbol correlated with a selected advertisement item. The presentation location is selected to make the presentation symbol discoverable by the user according to a discovery difficulty level calculated based on one or more of a plurality of campaign parameters defined by one or more campaign rules extracted from a campaign policy associated with the website.
Responding to the advertisement request with an instruction to embed the presentation symbol in the presentation location.

According to a second aspect of the present invention there is provided a system for dynamically expanding an online advertisement campaign in a virtual reality (VR) environment, comprising a communication interface adapted communicate with website presenting a VR presentation of a VR environment and one or more processors coupled to the communication interface, the processors(s) is adapted to execute a code, the code comprising:
Code instructions to receive an advertisement request from a website loaded by a client device for VR presentation a VR environment on a VR display to a user using a VR user interface to navigate in the VR presentation. The advertisement request comprises a request to present an advertisement items to the user currently presented with at least a portion of a certain page of the website.
Code instructions to select a presentation location in the certain page for embedding a presentation symbol correlated with a selected advertisement item. The presentation location is selected to make the presentation symbol discoverable by the user according to a discovery difficulty level calculated based on one or more of a plurality of campaign parameters defined by one or more campaign rules extracted from a campaign policy associated with the website.
Code instructions to respond to the advertisement request with an instruction to embed the presentation symbol in the presentation location.

In a further implementation form of the first and/or second aspects, the VR presentation is a member of a group consisting of: a VR presentation, an Augmented Reality (AR) presentation, a VR 360 presentation and/or an X Reality (XR) presentation.

In a further implementation form of the first and/or second aspects, the VR user interface comprises one or more wearable inertial sensors adapted to capture movement of one or more of: a head of the user and/or a hand of the user. Wherein the user navigates in the VR presentation by initiating the movement which is translated to VR navigation instructions identified by analyzing sensory data obtained from one or more of the inertial sensors.

In a further implementation form of the first and/or second aspects, the VR user interface comprises one or more inertial sensor adapted to capture movement of a client device used by the user. Wherein the user navigates in the VR presentation by moving the client device which is translated to VR navigation instructions identified by analyzing sensory data obtained from one or more of the inertial sensors.

In a further implementation form of the first and/or second aspects, the VR display is a member of a group consisting of: a head mounted VR display worn by the user and/or a flat display of a client device used by the user.

In a further implementation form of the first and/or second aspects, one or more of the processors are integrated in the client device used by the user, the client device comprising one or more communication interfaces to control the VR display.

In a further implementation form of the first and/or second aspects, the selected advertisement item is a coupon entitling a holder of the coupon to one or more member of a group consisting of: a gift product, a discount in a product price, a gift service, a discount in a service price and/or a contest entry right.

In a further implementation form of the first and/or second aspects, the selected advertisement item is selected according to one or more of the campaign rules.

In a further implementation form of the first and/or second aspects, one or more of the campaign rules define calculating the discovery difficulty level based on a maximum number of advertisement items available for the website.

In a further implementation form of the first and/or second aspects, one or more of the campaign rules define calculating the discovery difficulty level based on a maximum number of presentation locations available in the website.

In a further implementation form of the first and/or second aspects, one or more of the campaign rules define calculating the discovery difficulty level based on a maximum number of pages in the web site.

In a further implementation form of the first and/or second aspects, one or more of the campaign rules define calculating the discovery difficulty level based on a number of pages in the website previously traversed by the user.

In a further implementation form of the first and/or second aspects, one or more of the campaign rules define calculating the discovery difficulty level based on a number of presentation symbols previously discovered by the user.

In a further implementation form of the first and/or second aspects, one or more of the campaign rules define calculating the discovery difficulty level based on a user count of a plurality of users who visited the website.

In a further implementation form of the first and/or second aspects, one or more of the campaign rules define calculating the discovery difficulty level based on an average user time calculated by aggregating visit duration of a plurality of users who visited the website.

In a further implementation form of the first and/or second aspects, one or more of the campaign rules define calculating the discovery difficulty level based on one or more user attributes identified for the user.

In a further implementation form of the first and/or second aspects, one or more of the campaign rules define calculating the discovery difficulty level based on a discovery probability score calculated to estimate a probability that the user will discover the presentation symbol presented to the user by the client device.

In a further implementation form of the first and/or second aspects, one or more of the campaign rules define calculating the discovery difficulty level based on aggregation of at least some of the plurality of campaign parameters.

In an optional implementation form of the first and/or second aspects, each of one or more subsequent advertisement requests received from the website to provide one or more another advertisement items is responded with an instruction to embed another presentation symbol correlated with one or more another selected advertisement item in another presentation location in the VR environment. Each another presentation location is selected according to the discovery difficulty level calculated for each another selected advertisement item based on one or more of the campaign rules.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of dynamically expanding an online advertisement campaign in a VR environment, according to some embodiments of the present invention;

FIG. 2 is a schematic illustration of an exemplary system for dynamically expanding an online advertisement campaign in a VR environment, according to some embodiments of the present invention;

FIG. 3 is a screen capture of a VR environment marked with presentation locations selected for embedding advertisement items presentation symbols according to a discovery difficulty level, according to some embodiments of the present invention;

FIG. 4 is a screen capture of a VR environment embedding advertisement items presentation symbols placed in presentation locations selected according to a discovery difficulty level, according to some embodiments of the present invention; and

FIG. 5 is a screen capture of a User Interface (UI) of an exemplary campaign management application, according to some embodiments of the present invention.

### DETAILED DESCRIPTION OF SPECIFIC EMBODIMENTS OF THE INVENTION

The present invention, in some embodiments thereof, relates to dynamically expanding an online advertisement campaign in a virtual reality (VR) environment, and, more specifically, but not exclusively, to dynamically expanding an online advertisement campaign in a VR environment based on gamification of advertisement items discovery.

According to some embodiments of the present invention, there are provided methods, systems and computer program products for dynamically expanding an online advertisement campaign by applying gamification to increase efficiency of the advertisement campaign and improving engagement with a user presented with a VR presentation of a VR environment. The online advertisement campaign efficiency may be significantly improved by engaging with the user in a game and/or quest like session in which the user is encouraged to search and discover advertisement items embedded in the VR presentation while exploring the VR environment. The advertisement items may include, for example, a coupon entitling a holder of the coupon to one or more benefits, for example, a gift product, a discount in a product price, a gift service, a discount in a service price, a contest entry right and/or the like.

The user may use a client device, for example, a computer, a mobile device (e.g. a Smartphone, a tablet etc.) and/or the like for downloading the VR presentation from one or more websites hosting at least a portion of the VR environment. The client device may control a VR user interface comprising a VR display for presenting the VR presentation to the user and one or more VR sensors adapted to monitor, capture and/or track movement of the user which is translated to VR navigation instructions for navigating in the VR presentation and/or in the VR environment. The VR display may be a 3D (stereoscopic) VR display, for example, a Head Mounted Display (HMD), a stereoscopic goggles display and/or the like. The VR display may also be a standard flat display integrated in the client device used by the user. The VR sensors may include, for example, an inertial sensor and/or the like configured to monitor, capture and track motion, movement and/or gestures of the user, for example, a head movement, a hand movement (gesture), a bodily movement and/or the like. The VR interface may be provided by the client device itself and/or by one or more additional devices such as the HMD, the googles which may be controlled by the client device. Optionally, the functionality of the mobile device is integrated in the VR interface, for example, an integrated HMD, integrated goggles and/or the like which may further integrate one or more of the VR sensors. As such, the integrated VR interface may directly communicate with the remote website(s) to download the VR presentation.

While exploring the VR environment and presented with the VR presentation, the user may be presented with one or more advertisement items. Specifically, the advertisement items may be presented to the user using gamification, i.e. engaging the users in a game and/or a quest for challenging the user to search and discover the advertisement items.

The advertisement items may be selected for the user based on a discovery difficulty level calculated for each of the advertisement items available for the VR content website from which the VR presentation is downloaded for presentation to the user. The advertisement items may also be selected based on the nature, application and/or attributes of the VR environment downloaded from the VR content website. For example, for a VR environment simulating and/or augmenting an accommodation facility (e.g. hotel, motel, lodge, resort, house, camping site, real-estate property, time share property, etc.) the selected advertisement items may include, for example, free breakfast, discount coupon to a restaurant associated with the accommodation facility, complementary shuttle service and/or the like.

Moreover, one or more presentation locations (marker(s)) in which to embed the selected advertisement items (specifically, symbols associated with the selected advertisement items) in the VR presentation may be also selected based on the calculated discovery difficulty level. The discovery difficulty level is directed to maintain balance between the need to introduce a non-trivial challenge for the user to entice him to search and discover the VR environment and hence the presentation symbols and the need to avoid discouraging the user by embedding the presentation symbols such that they are too difficult to find. The discovery difficulty level is therefore calculated to estimate the effort required by the user to discover the symbols associated with the selected advertisement items and embedded in the VR presentation. As such the discovery difficulty level may translate to how the advertisement items' symbols are embedded in the VR presentation, i.e. whether the symbols are embedded to be conspicuous, obvious, visible, obscure and/or concealed.

The discovery difficulty level may be calculated based on one or more campaign parameters defined by one or more campaign rules of a campaign policy associated with the VR content website from which the VR presentation is downloaded. The campaign parameters may include for example, maximum number of advertisement items available for the VR content website, maximum number of presentation locations available in the VR presentation for embedding the advertisement items' symbols, maximum number of pages in the in the VR content website, number of pages in the in the VR content website previously traversed by the user, number of presentation symbols previously discovered by the user, user count indicating number of users visiting or visited the VR content website, average user time indicating the average time spent by users in the VR content website, user attributes of the user, a discovery probability score calculated for the advertisement items' symbols and/or the like.

Based on the calculated discovery difficulty level, one or more of the advertisement items may be selected and embedded in the VR presentation in presentation locations which may be also selected based on the calculated discovery difficulty level.

The user may be further engaged with embedding additional advertisement items in the VR presentation to encourage him to further explore the VR environment and search for additional advertisement items embedded in the VR environment in presentation locations selected based on the discovery difficulty level.

Dynamically expanding the online advertisement campaign in the VR environment by selecting advertisement items and their presentation locations may introduce significant advantages compared to existing methods and/or applications for selecting advertisement items for presentation to a user consuming online content.

First, it has been researched and established that gamification may be highly effective for improving user engagement in a plurality of applications ranging from education and learning to therapy and medical treatment adherence among many other. Therefore applying gamification in the online advertisement campaign, specifically engaging with the user in a game or quest like activity may significantly increase effectivity of the online advertisement campaign. Moreover, the VR environment presented to the user may be highly suitable and efficient for introducing and instituting gamification since in the simulated VR environment may be very realistic and the user may have great freedom of action and movement for exploring the VR environment as may be done in real world games and/or quests.

Moreover, selecting the advertisement items according to the discovery difficulty level may allow controlling and adjusting the ability of the user to discover the advertisement items and/or the discovery rate. Controlling the advertisement items discovery may allow for significantly increased engagement with the user while adapting to the campaign parameters.

Furthermore, selecting the advertisement items according to the user attributes identified for each specific user may allow specifically customizing the discovery ability and/or the discovery rate according to the abilities identified and/or estimated for the specific user.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer Program code comprising computer readable program instructions embodied on a computer readable medium may be transmitted using any appropriate medium, including but not limited to wireless, wire line, optical fiber cable, RF, etc., or any suitable combination of the foregoing.

The program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code can be downloaded to respective computing/processing devices from a computer readable storage medium or to an external computer or external storage device via a network, for example, the Internet, a local area network, a wide area network and/or a wireless network.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

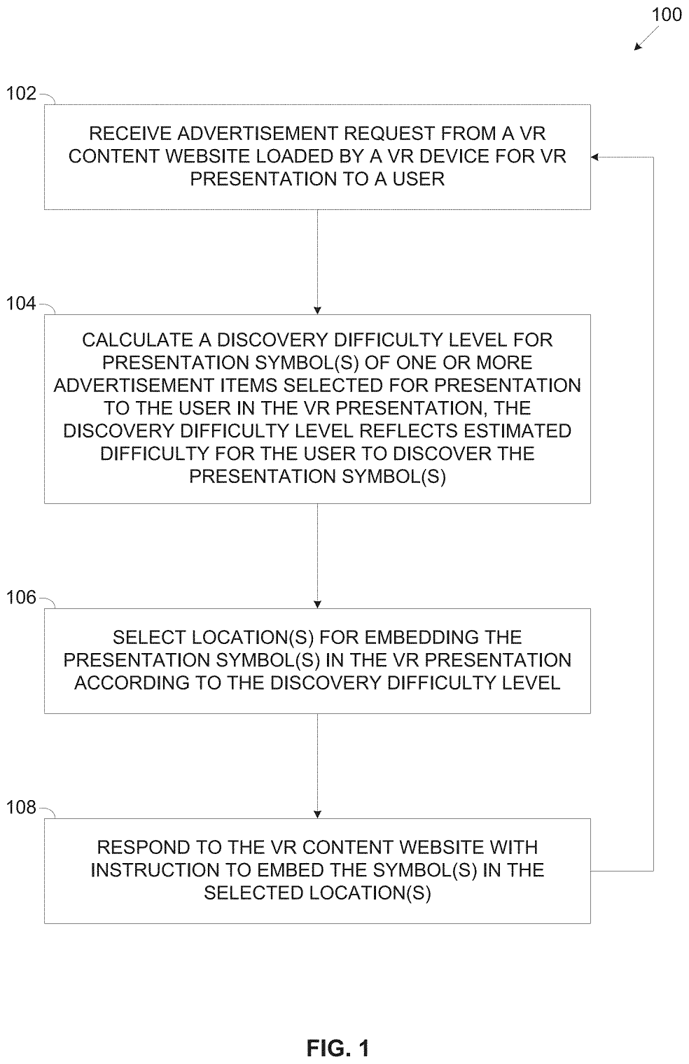

Referring now to the drawings, FIG. 1 is a flowchart of an exemplary process of dynamically expanding an online advertisement campaign in a VR environment, according to some embodiments of the present invention. An exemplary process 100 may be executed by a campaign management system for dynamically expanding an online advertisement campaign applying gamification to improve engagement with a user presented with a VR presentation of a VR environment by encouraging the user to discover advertisements items symbols embedded in the VR presentation.

The online advertisement campaign may be expanded by engaging with the user in a game and/or quest like session in which the user is encouraged to search and discover advertisement items, for example, a coupon entitling a holder of the coupon to one or more benefits, for example, a gift product, a discount in a product price, a gift service, a discount in a service price, a contest entry right and/or the like while exploring the VR environment. The advertisement items are associated with respective presentation symbols which may be embedded in the VR presentation in presentation locations selected based on a discovery difficulty level. The discovery difficulty level calculated for the presentation symbols is directed to maintain balance between the need to introduce a non-trivial challenge for the user to entice him to search and discover the presentation symbols and the need to avoid discouraging the user by embedding the presentation symbols such that they are too difficult to find.

The user may use a client device for downloading the VR presentation from a website hosting at least a portion of the VR environment. The client device may control a VR user interface comprising a VR display for presenting the VR presentation and one or more VR sensors used to monitor, capture and/or track movement of the user translated to navigation instructions for navigating in the VR presentation and/or in the VR environment.

The campaign management system may receive one or more advertisement requests from the website while the user navigates in the VR presentation. The advertisement request(s) are directed to receive one or more advertisement items which may be embedded in the VR presentation for presentation to the user.

In response the campaign management system may instruct the website to embed one or more presentation symbols associated with one or more of the advertisement item(s). Moreover, the campaign management system may instruct the website to embed the presentation symbol(s) in certain presentation location(s) in the VR presentation.

The campaign management system may select the presentation location(s) (marker(s)) for embedding the presentation symbol(s) according to a discovery difficulty level calculated for each of the selected advertisement item(s). The discovery difficulty level may be calculated based on one or more campaign parameters defined by one or more campaign rules extracted from the campaign policy. The discovery difficulty level indicates the effort estimated for the user to discover the embedded presentation symbol(s) in the VR presentation. In other words, the discovery difficulty level indicates a level of obviousness, visibility, obscurity and/or concealment of embedded presentation symbol(s) in the VR presentation.

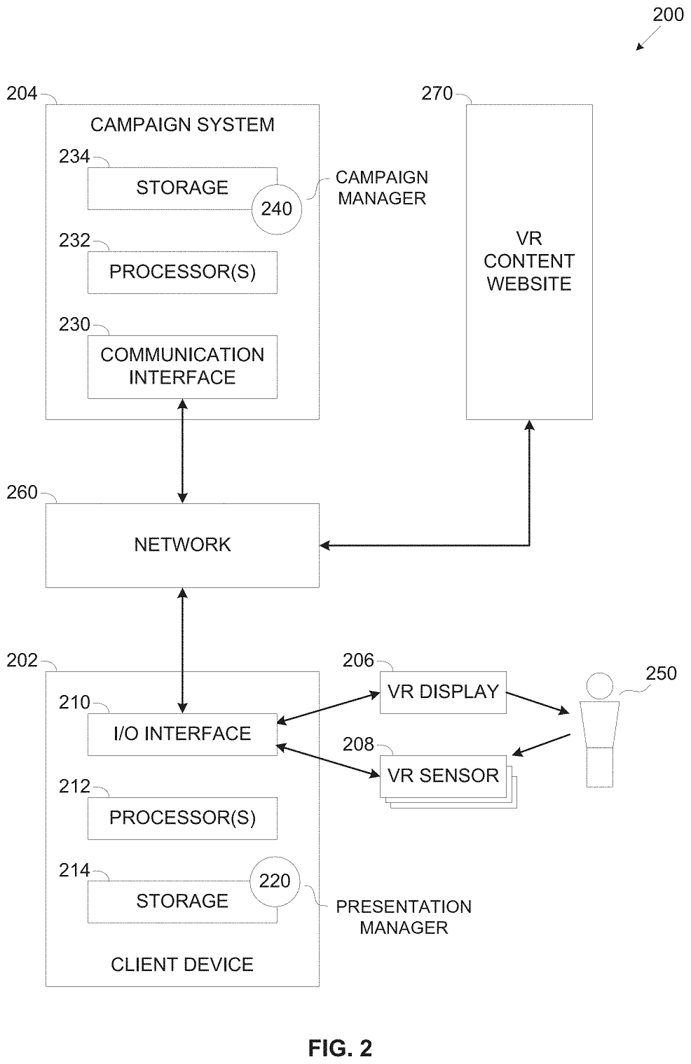

Reference is also made to FIG. 2, which is a schematic illustration of an exemplary system for dynamically expanding an online advertisement campaign in a VR environment, according to some embodiments of the present invention. An exemplary system 200 may include a campaign management system 204 for executing the process 100 to dynamically expand an online advertisement campaign targeting one or more users 250 using respective client devices 202 for downloading a VR presentation from one or more VR content websites 270 hosting at least part of respective VR environments.

The exemplary process 100 and the exemplary system 200 are described herein after for a single user 204 using a single client device 202 for downloading the VR presentation from a single VR content website 270. However, this should not be construed as limiting since the process 100 and the system 200 may be applied for a expanding multiple online advertisement campaigns for a plurality of users such as the user 204 presented with VR presentation downloaded at least partly form a plurality of VR content websites 270.

The client device 202, for example, Smartphone, a Tablet, a computer, a laptop and/or the like may communicate with a VR user interface comprising a VR display 206 for presenting the VR presentation to the user 250 and one or more VR sensors 208 for capturing motion (VR) navigation instructions from the user 250. The client device 202 may include an Input/Output (I/O) interface 210, a processor 212 and storage 214.

The I/O interface 210 may include one or more wired and/or wireless interfaces for communicating with the VR display 206 and/or the VR sensor(s) 208, for example, a wireless Local area Network (WLAN, e.g. Wi-Fi) interface, a Bluetooth interface, a Radio Frequency (RF) interface, an analog interface, a Universal Serial Bus (USB) interface, a network interface, a proprietary interface and/or the like. The I/O interface 210 may further include one or more wired and/or wireless network interfaces for connecting to a network 260 comprising one or more networks, for example, a Local area Network (LAN), a Wide area Network (WAN), a Metropolitan Area Network (MAN), a WLAN, a cellular network, and/or the internet to facilitate communication with more or more remote locations and/or resources. Specifically, the client device 202 may use the I/O interface 210 for communicating with the VR content website 270 hosted by one or more servers, cloud services, cloud platforms and/or the like to download the VR presentation.

The processor 212, homogenous or heterogeneous, may include one or more processors arranged for parallel processing, as clusters and/or as one or more multi core processors. The storage 214 may include one or more non-transitory persistent storage devices, for example, a Read Only Memory (ROM), a Flash array, a hard drive and/or the like. The storage 206 may also include one or more volatile devices, for example, a Random Access Memory (RAM) component, a cache component and/or the like.

The processor(s) 212 may execute one or more software modules such as, for example, an operating system, OS a process, a script, an application, an agent, a utility, a tool and/or the like each comprising a plurality of program instructions stored in a non-transitory medium (program store) such as the storage 214 and executed by one or more processors such as the processor(s) 212. For example, the processor 212 may execute a presentation manager software module 220 for controlling the VR presentation presented to the user 250 by the VR display 206 and receiving the VR navigation instructions initiated by the user 250 as captured by the VR sensor(s) 208. The presentation manager 220 may communicate with the VR content website 270 to download the VR presentation. The presentation manager 220 may utilize one or more software modules, for example, a browsing application (e.g. a web browser), a local agent and/or the like for communicating with the VR content website 270. The presentation manager 220 may further instruct the VR display 206 to create a 3D VR presentation in order to create a more realistic presentation allowing the user 250 to perceive and/or navigate in the VR presentation of the VR environment more efficiently.

The presentation manager 220 may optionally utilize one or more hardware elements for it operation, for example, a circuit, a component, an Integrated Circuit (IC), an Application Specific Integrated Circuit (ASIC), a Field Programmable Gate Array (FPGA), a Digital Signals Processor (DSP) and/or the like.

The VR display 206 may include a 3D (stereoscopic) VR display, for example, a 3D HMD, a stereoscopic goggles display and/or the like. The VR display 206 may also include a standard flat display, specifically a display of the client device 202, for example, a computer, a laptop screen, a mobile device screen (e.g. Smartphone screen, tablet screen, etc.) and/or the like. The 3D stereoscopic VR display 206 may support a 3D stereoscopic VR presentation which includes visual depth presentation. The 3D stereoscopic VR display 206 may naturally support an interactive presentation which is adapted according to the VR navigation instructions initiated by the user 250. The flat VR display 206 on the other hand may not support the 3D stereoscopic VR presentation but may still support the interactive presentation which is adapted according to the VR navigation instructions initiated by the user 250.

The VR sensor(s) 208 may include one or more inertial sensors, for example, an accelerometer, a gyroscope, an Inertial Measurement Unit (IMU) and/or the like adapted to monitor, capture and/or track motion and/or movements of the user 250, for example, head movements, hand movements, bodily movements and/or the like. The motion and/or movements of the user 250 may be translated to the VR navigation instructions. The VR sensor(s) 208 may be worn, for example, worn, placed, attached, coupled and/or the like by the user 250. Optionally, in particular in case the VR display 206 is utilized by the client device 202, one or more of the VR sensor(s) 208, for example, an accelerometer, a gyroscope and/or the like may be integrated in the client device 202 to monitor, capture and/or track motion and/or movements of the client device 202 as operated by the user 250. Specifically, the VR sensor(s) 208 may be utilized by motion sensors typically available in the client device 202.

In some embodiments of the present invention, one or more components of the client device 202, specifically the I/O interface 210 and/or part thereof, the processor 212 and/or the storage 214 may be integrated in the VR display 206. For example, the presentation manager 220 may be executed by the processor 212 of the VR display 206 from the storage 214 of the integrated VR display 206 while communicating with the VR content website 270 through the client device 202 which serves as a relay, a gateway, a bridge and/or the like to provide network connectivity for the integrated VR display 206. In such case the presentation manager 220 executed by the processor 212 of the VR display 206 may communicate with the client device 202 through a local communication interface, for example, Wi-Fi provided by the I/O interface 210 of the VR display 206. The client device 202 may communicate with the VR content website 270 via the network 260, for example, the cellular network. Moreover, in such embodiments one or more of the VR sensors 208 may be integrated in the VR display 206. For example, in case the VR display 206 is utilized by the 3D HMD, one or more of the VR sensor(s) 208 adapted to capture and/or track head movements of the user 250 may be integrated in the 3D HMD VR display 206.

The campaign management system 204 may comprise a communication interface 230 to connect to the network 260, a processor(s) 232 such as the processor(s) 212 for executing the process 100 and storage 234 such as the storage 214. Specifically, the communication interface 230 may be used by the campaign management system 204 for communicating with the VR content website 270. The storage 274 may further comprise one or more network storage devices, for example, a storage server, a Network Accessible Storage (NAS), a network drive and/or the like accessible through the communication interface 230.

The processor(s) 232 may execute one or more software modules each comprising a plurality of program instructions stored in a non-transitory medium (program store) such as the storage 234 and executed by one or more processors such as the processor(s) 232. For example, the processor(s) 232 may execute a campaign manager software module 240 for receiving advertisement requests from the VR content website 270 and responding with instructions to embed one or more presentation symbols associated with respective advertisement items in the VR presentation presented to the user 250.

Optionally, the campaign management system 204 and/or the campaign manager 240 executed by the campaign management system 204 are implemented as one or more cloud computing services, for example, an Infrastructure as a Service (IaaS), a Platform as a Service (PaaS), a Software as a Service (SaaS) and/or the like such as, for example, Amazon Web Service (AWS), Google Cloud, Microsoft Azure and/or the like.

As shown at 102, the process 100 may start with the campaign manager 240 receiving one or more advertisement requests from the VR content website 270 hosting at least part of a VR environment.

One or more pages of the VR content website 270 may be loaded by the client device 202 which may instruct the VR display 206 to present the VR presentation of at least part of the VR environment to the user 250. The VR presentation may include, for example, a VR presentation, an Augmented Reality (AR) presentation, a VR 360 presentation, an X Reality (XR) presentation and/or the like collectively designated VR presentation herein after.

The VR presentation may include synthetic presentation data which may optionally be fused, overlaid and/or combined with real world presentation data. For example, the VR presentation may include synthetic presentation data which portrays a completely virtual environment. In another example, the VR presentation may include synthetic presentation data overlaid to augment real world presentation data, for example, an image, a picture, a video stream and/or the like captured at least in part by one or more imaging sensors, for example, a camera, an infrared sensor, a night vision sensors, a thermal sensor and/or the like. In particular, the real world presentation data is captured by one or more imaging sensors deployed to depict the environment of the user 250. For example, in case the VR display 206 is utilized by the 3D HMD, the real world presentation data may be captured by one or more imaging sensors integrated in the 3D HMD. In another example, in case the VR display 206 is utilized by the client device 202, the real world presentation data may be captured by one or more imaging sensors integrated in the client device 202. Optionally, the real world presentation data and/or part thereof may be obtained, retrieved and/or received from one or more storage resources storing the captured real world presentation data which was captured in the past.

While presented with the VR presentation, the user 204 may initiate movements, motions and/or gestures which may be captured by the VR sensor(s) 208 and translated to VR navigation instructions. The user 250 may therefore issue VR navigation instructions to navigate through the VR presentation, navigate to other segments of the VR environment, select one or more items presented in the VR presentation, initiate actions in the VR environment and/or the like.

The campaign manager 240 may receive multiple advertisement requests from the VR content website 270 while the user 250 navigates in the VR environment hosted by the VR content website 270. The campaign manager 240 is therefore adapted to dynamically expand an online advertisement campaign targeting the users, for example, the user 250 visiting the VR content website 270 and exploring (navigating) the VR environment hosted by the VR content website 270.

As shown at 104, the campaign manager 240 may calculate a discovery difficulty level for advertisement items selected for presentation to the user 250 viewing the VR presentation on the VR display 206. The campaign manager 240 may calculate the discovery difficulty level according to one or more campaign parameters defined by one or more campaign rules extracted from a campaign policy associated with the VR content website 270. The discovery difficulty level indicates the effort estimated for the user 250 to discover presentation symbol(s) associated with the selected advertisement item(s) that are embedded in the VR presentation. As such the discovery difficulty level may translate to how the presentation symbol(s) are embedded in the VR presentation, i.e. whether the presentation symbol(s) are embedded to be conspicuous, obvious, visible, obscure and/or concealed.

The campaign manager 240 may select one or more of the advertisement items, for example, a coupon entitling a holder of the coupon to one or more benefits, for example, a gift product, a discount in a product price, a gift service, a discount in a service price, a contest entry right and/or the like according to one or more of the campaign rules defined by the campaign policy.

For example, assuming the VR content website 270 hosts a VR environment of an accommodation facility such as, for example, a hotel, a motel, a lodge, a resort, an inn, a house, a camping site, a real-estate property, a time share property and/or the like. In such case, one or more campaign rules defined by the campaign policy associated with the VR content website 270 may dictate selecting one or more advertisement items relating to the accommodation facility, for example, a free breakfast, a discount coupon to a restaurant of the accommodation facility, a complementary shuttle service and/or the like. In another example, assuming the VR content website 270 hosts a VR environment of a cabin interior of an airliner, i.e. a passenger aircraft planned for flight to a certain flight to a certain destination. In such case one or more campaign rules defined by the campaign policy associated with the VR content website 270 may dictate selecting one or more advertisement items relating to the airliner, for example, an upgrade to a higher class, a discount coupon for a shuttle service at the destination, an entry right to a contest (raffle) for free flight tickets and/or the like. In another example, assuming the VR content website 270 hosts a VR environment of at least part of a certain city, i.e. several streets and/or blocks. In such case one or more campaign rules defined by the campaign policy associated with the VR content website 270 may dictate selecting one or more advertisement items relating to the products and/or services found in nearby locations in close proximity to the street currently explored by the user 250 using the VR interface. These products and/or services may include, for example, restaurant(s), retail shop(s), government facilities, public transportation and/or the like.

The campaign manager 240 may calculate the discovery difficulty level for the selected advertisement item(s) according to one or more of the campaign parameters defined by one or more of the campaign rules extracted from the campaign policy associated with the VR content website 270. The campaign parameters may relate to the VR content website 270, to the user 250, to the advertisement items availability and/or the like.

For example, one or more of the campaign rules may dictate the campaign manager 240 to calculate the discovery difficulty level based on a maximum number of advertisement items available for the VR content website 270. For example, assuming the number of advertisement items available for the VR content website 270 is very high. In such case the campaign rule(s) may be defined to dictate the campaign manager 240 to assign a significantly high discovery difficulty level to the presentation symbols of at least some of the selected advertisement items. In contrast, assuming the number of advertisement items available for the VR content website 270 is significantly small, the another example campaign rule(s) may be defined to dictate the campaign manager 240 to assign a significantly low discovery difficulty level to the presentation symbols of one or more of the selected advertisement items. Moreover, the campaign rule(s) may dictate the campaign manager 240 to assign a gradually increasing discovery difficulty level to the presentation symbols of a plurality of selected advertisement items. For example, based on the campaign rule(s), the campaign manager 240 may assign a relatively low

In another example, one or more of the campaign rules may dictate the campaign manager 240 to calculate the discovery difficulty level based on a maximum number of presentation locations available in the VR presentation for embedding the presentation symbols of selected advertisement items. For example, assuming the VR presentation depicts a complex VR environment the campaign rule(s) may be defined to dictate the campaign manager 240 to assign a significantly low discovery difficulty level to the presentation symbols of at least some of the selected advertisement items. These campaign rule(s) may be defined as such to prevent discouraging the user 250 from seeking and discovering the presentation symbol(s) of selected advertisement item(s). Such complex VR environments may include, for example, a certain location, for example, a hotel, an airliner, a street and/or the like comprising a plurality of separate spaces that may be explored by the user 250 using the VR interface to navigate within the VR presentation and discover the presentation symbol(s). In another example, the complex VR environment may include a certain location (area) populated with multiple objects, for example, furniture and/or the like which the user 250 using the VR interface may interact with, for example, move, open and/or the like to discover the presentation symbol(s). In contrast, assuming the VR presentation depicts a plane, basic and/or simple VR environment the campaign rule(s) may be defined to dictate the campaign manager 240 to assign a significantly high discovery difficulty level to the presentation symbols of at least some of the selected advertisement items. These campaign rule(s) may be defined as such to present a challenge for the user 250 and maintain or increase engagement of the user 250 in the online advertisement campaign. Such basic VR environments may include, for example, a single room populated with very few (or no) furniture and having no separate spaces. The user 250 using the VR interface may easily and rapidly explore such this single room and the objects presented in it.

In another example, one or more of the campaign rules may dictate the campaign manager 240 to calculate the discovery difficulty level based on a maximum number of pages in the in the VR content website 270, in particular, a maximum number of pages constituting the VR environment. For example, assuming the VR content website 270 comprises a significantly high number of pages, the VR environment may be significantly complex. In such case the campaign rule(s) may be defined to dictate the campaign manager 240 to assign a significantly low discovery difficulty level to the presentation symbols of at least some of the selected advertisement items. These campaign rule(s) may be defined as such to encourage the user 250 to traverse a large number of pages and prevent a scenario in which the user 250 is unable to discover sufficient presentation symbols and stop exploring the VR environment and potentially leave the VR content website 270. In contrast, assuming the VR content website 270 comprises a significantly low number of pages, the VR environment may be significantly plane, basic and/or simple. In such case the campaign rule(s) may be defined to dictate the campaign manager 240 to assign a significantly high discovery difficulty level to the presentation symbols of at least some of the selected advertisement items. These campaign rule(s) may be defined as such to present a major challenge for the user 250 in searching and discovering presentation symbols in the restricted and limited VR environment which the user 250 may easily, rapidly and/or effortlessly explore.

Moreover, one or more of the campaign rules may dictate the campaign manager 240 to calculate the discovery difficulty level based on a number of pages in the in the VR content website 270 previously traversed (visited) by the user 250 during the current VR session, i.e. the number of pages the user 250 already traversed. For example, the campaign rule(s) may be defined to dictate the campaign manager 240 to assign a gradually increasing discovery difficulty level to the presentation symbols of at least some of the selected advertisement items as the user 250 advances in the VR environment. These campaign rule(s) may be defined as such to present a gradually increasing challenge for the user 250 in searching and discovering the presentation symbols starting with relatively easy to find presentation symbols and gradually advancing to harder to discover presentation symbols. In another example, the campaign rule(s) may be defined to dictate the campaign manager 240 to assign a gradually decreasing discovery difficulty level to the presentation symbols of at least some of the selected advertisement items as the user 250 advances in the VR environment. These campaign rule(s) may be defined as such to present a gradually reduced challenge for the user 250 in searching and discovering the presentation symbols starting with relatively hard to find presentation symbols while the user 250 is traversing the first pages in the of the VR content website 270 and gradually reducing the challenge to encourage the user 250 to traverse additional pages of the VR content website 270.

In another example, one or more of the campaign rules may dictate the campaign manager 240 to calculate the discovery difficulty level based on a number of presentation symbols previously discovered by the user 250 during the current VR session, i.e. the number of presentation symbols the user 250 already found. For example, the campaign rule(s) may be defined to dictate the campaign manager 240 to assign a gradually increasing discovery difficulty level to the presentation symbols of at least some of the selected advertisement items as the user 250 discovers additional presentation symbols. These campaign rule(s) may be defined as such to present a gradually increasing challenge for a user 250 who successfully discovered a relatively high number of previously presented presentation symbols while maintaining or reducing the challenge for a user 250 who was able to discover a relatively low number (or no) of previously presented presentation symbols.

In another example, one or more of the campaign rules may dictate the campaign manager 240 to calculate the discovery difficulty level based on a user count of a plurality of users such as the user 250 who visited the VR content website 270. The user count may relate to the number of users 250 who visited the VR content website 270 in the past and/or the number of users 250 who concurrently visit the VR content website 270 at the same time as the user 250. For example, the campaign rule(s) may be defined to dictate the campaign manager 240 to assign a significantly low discovery difficulty level to the presentation symbols of at least some of the selected advertisement items in case a relatively low number of users 250 have visited the VR content website 270 in the past. The campaign rule(s) may be defined as such to encourage new users 250 to visit the VR content website 270. In another example, the campaign rule(s) may be defined to dictate the campaign manager 240 to assign a significantly high discovery difficulty level to the presentation symbols of at least some of the selected advertisement items in case an extremely large number of users 250 have visited the VR content website 270 in the past. These campaign rule(s) may be defined as such to present a major challenge for a frequently visited and popular VR content website 270. In another example, the campaign rule(s) may be defined to dictate the campaign manager 240 to assign a significantly high discovery difficulty level to the presentation symbols of at least some of the selected advertisement items in case a large number of users 250 are currently visiting the VR content website 270, i.e. at the same time. These campaign rule(s) may be defined as such to present a major challenge and establish competition between the users 250 concurrently visiting the VR content website 270.

Moreover, the campaign rule(s) may be defined to dictate the campaign manager 240 to assign the discovery difficulty level to the presentation symbols of at least some of the selected advertisement items according to the number of users 250 currently visiting the VR content website 270 combined with the number of advertisement items available for the VR content website 270. For example, the campaign rule(s) may dictate the campaign manager 240 to assign high discovery difficulty level to at least some of the presentation symbols in case a large number of users 250 currently visit the VR content website 270 and the number of available advertisement items is relatively small.

In another example, one or more of the campaign rules may dictate the campaign manager 240 to calculate the discovery difficulty level based on an average user time calculated by aggregating visit durations of a plurality of users 250 who visited the VR content website 270 in the past. For example, the campaign rule(s) may be defined to dictate the campaign manager 240 to assign a significantly low discovery difficulty level to the presentation symbols of at least some of the selected advertisement items in case the average user time is short, i.e. the users 250 spent a short time period exploring the VR environment provided by the VR content website 270. The campaign rule(s) may be defined as such in attempt to attract and/or persuade the user 250 to extend his exploration time period of the VR environment provided by the VR content website 270. In contrast, the campaign rule(s) may be defined to dictate the campaign manager 240 to assign a significantly high discovery difficulty level to the presentation symbols of at least some of the selected advertisement items in case the average user time is long, i.e. the users 250 spent a long time period exploring the VR environment provided by the VR content website 270. These campaign rule(s) may be defined as such in attempt to present an increased challenge for the user 250 who is expected to explore the VR environment for a long time period. In another example, the campaign rule(s) may be defined to dictate the campaign manager 240 to assign a lower discovery difficulty level to the presentation symbols as the time spent by the user 250 to explore the VR environment provided by the VR content website 270 is upcoming the average user time. These campaign rule(s) may be defined as such in attempt to encourage the user 250 to extend his exploration of the VR environment.

In another example, one or more of the campaign rules may dictate the campaign manager 240 to calculate the discovery difficulty level based on one or more user attributes identified for the user 250. The user attributes may include, for example, age, gender, geographical residence area and/or the like. The user attributes may further include previous (past) activity of the user 250 at the VR content website 270 and/or at one or more other VR content websites such as the VR content website 270. The user attributes may of the user 250 may be identified using one or more techniques and/or methods, for example, registration information provided by the user 250 during a registration process to the VR content website 270, a cookie created for the user 250 and retrieved from the client device 202, specifically from the presentation manager 220 and/or the like. For example, the campaign rule(s) may be defined to dictate the campaign manager 240 to assign a significantly low discovery difficulty level to the presentation symbol of at least some of the selected advertisement items in case the user 250 is identified as a child and/or a teenager, for example, younger than 14 who may be less experienced and/or proficient in exploring the VR environment provided by the VR content website 270. These campaign rule(s) may be defined as such in order to allow the young user 250 to discover the presentation symbol(s) fairly easily thus avoid discouraging the young user 250. In another example, the campaign rule(s) may be defined to dictate the campaign manager 240 to assign a significantly low discovery difficulty level to the presentation symbol(s) in case the user 250 is identified as residing in a certain geographical location in which very few users 250 have downloaded the VR environment provided by the VR content website 270. These campaign rule(s) may be defined as such in order to encourage the user 250 to experience successful quest for the presentation symbol(s) and share his experience with other potential users 250 to increase the number of users 250 residing tin the certain geographical area that may visit the VR content website 270.

In another example, one or more of the campaign rules may dictate the campaign manager 240 to calculate the discovery difficulty level based on a discovery probability score indicating a probability that the user 250 will discover one or more of the presentation symbol(s) to be embedded in the VR presentation. A high discovery probability score indicates a high probability that the user 250 will discover the presentation symbol(s) while a low discovery probability score indicates a low probability that the user 250 will discover the presentation symbol(s). The probability score may be calculated based on analysis of successful and/or failed discovery attempts of the presentation symbol(s) as identified for a plurality of users 250 who visited the VR content website 270 in the past and explored the VR environment provided by the VR content website 270. For example, the campaign rule(s) may dictate the campaign manager 240 to assign low discovery difficulty level to at least some of the presentation symbols for which a low discovery probability score is calculated. In contrast, the campaign rule(s) may dictate the campaign manager 240 to assign low discovery difficulty level to at least some of the presentation symbols for which a low discovery probability score is calculated.

The campaign rules may be further defined to dictate the campaign manager 240 to calculate the discovery difficulty level based on aggregation one or more of the campaign parameters. As described herein before, the campaign parameters may include, for example, the maximum number of advertisement items available for the VR content website 270, the maximum number of presentation locations available in the VR presentation for embedding the presentation symbol(s), the maximum number of pages in the in the VR content website 270, the number of pages in the in the VR content website 270 previously traversed by the user 250, the number of presentation symbols previously discovered by the user 250, the users count such as the users 250 who visit/visited the VR content website 270, the average user time, the user attributes of the user 250, the discovery probability score calculated for one or more presentation symbol(s) and/or the like.

The campaign manager 240 may apply the exemplary computation presented in equation 1 below to calculate a probability of the user 250 viewing a certain advertisement item x of a plurality of advertisement items X available for the VR content website 270.

$$x = \{ \begin{matrix}0 & if X ∼ N ( 1 , 100 ) - \frac{{\sum }_{i = 1}^{∞} c}{\overline{u}} \cdot 100 \leq 0 \\ 1 & if X ∼ N ( 1 , 100 ) - \frac{{\sum }_{i = 1}^{∞} c}{\overline{u}} \cdot 100 > 0\end{matrix} \} \qquad Equation 1$$

Where c designates the sum of the plurality of advertisement items X, u designates the average daily user count of the users 250 visiting the VR content website 270 per day.

The calculation in equation 1 applies an equal probability for presenting presentation symbols across a random number of advertisement items selected from advertisement items X available for the VR content website 270

The campaign manager 240 may then use the exemplary calculation formulated in equation 2 below to calculate the number of presentation symbols that may be embedded in the VR presentation for each advertisement item x based on the probability that the respective advertisement item x will be discovered by the user 250 exploring the VR environment of the VR content website 270.

$$f ( x ) = \frac{{\sum }_{1}^{∞} m - ( {\sum }_{1}^{∞} m \cdot \frac{d}{100} )}{\overline{p}} \cdot x \qquad Equation 2$$

Where m designates each of the presentation locations available in the VR content website 270, d designates the discovery difficulty level (expressed in percentage) calculated for the respective presentation location m, p designates the average count of pages traversed by a plurality of users 250 visiting the VR content website 270 and x is the calculated probability that the respective advertisement item x will be discovered by the user 250.

As shown at 106, the campaign manager 240 may select a presentation location for embedding, in the VR presentation, the presentation symbol of the advertisement item selected for presentation to the user 250. In particular, the campaign manager 240 selects the presentation locations for embedding the presentation symbol according to the difficulty level calculated for each of the selected advertisement item(s). For example, assuming the discovery difficulty level calculated for a certain advertisement item is relatively high, the campaign manager 240 may select a hard to discover presentation location in the VR presentation for embedding a respective presentation symbol associated with the certain advertisement symbol, for example, out of plain sight, behind an object presented in the VR presentation, in a hidden space, in an object (e.g. box, closet, etc.) and/or the like. Selecting the hard to find presentation location may present a major discovery challenge for the user 250 to discover (find) the respective presentation symbol. In another example, assuming the discovery difficulty level calculated for a certain advertisement item is relatively low, the campaign manager 240 may select an easy to discover presentation location in the VR presentation for embedding a respective presentation symbol associated with the certain advertisement symbol, for example, in plain sight, on top an object presented in the VR presentation and/or the like. This may allow the user 250 to easily discover the respective presentation symbol.

As shown at 108, the campaign manager 240 may respond to the advertisement request received from the VR content website 270 with instructions to embed the presentation symbol(s) of the selected advertisement item(s) in the presentation location(s) selected based on the discovery difficulty level calculated for each advertisement item.

The VR content website 270 may then embed the presentation symbol(s) of the selected advertisement item(s) in their selected presentation location(s) in the VR presentation. The presentation manager 220 communicating with the VR content website 270 may retrieve at least part of the VR presentation embedded with the presentation symbol(s) of the selected advertisement item(s). The presentation manager 220 instruct the VR display 206 to present the VR presentation embedded with the presentation symbol(s) thus allowing the user 250 discover the embedded presentation symbol(s).

The process 100 may be an iterative process comprising a plurality of iterations. During each of the iterations the campaign manager 240 may receive one or more additional (other) advertisement requests from the VR content website 270. The campaign manager 240 may select additional (other) advertisement item(s) and may select additional presentation location(s) for embedding the presentation symbol(s) associated with the additionally selected advertisement item(s). The campaign manager 240 may further instruct the VR content website 270 to embed the presentation symbol(s) in the VR presentation presented to the user 250.

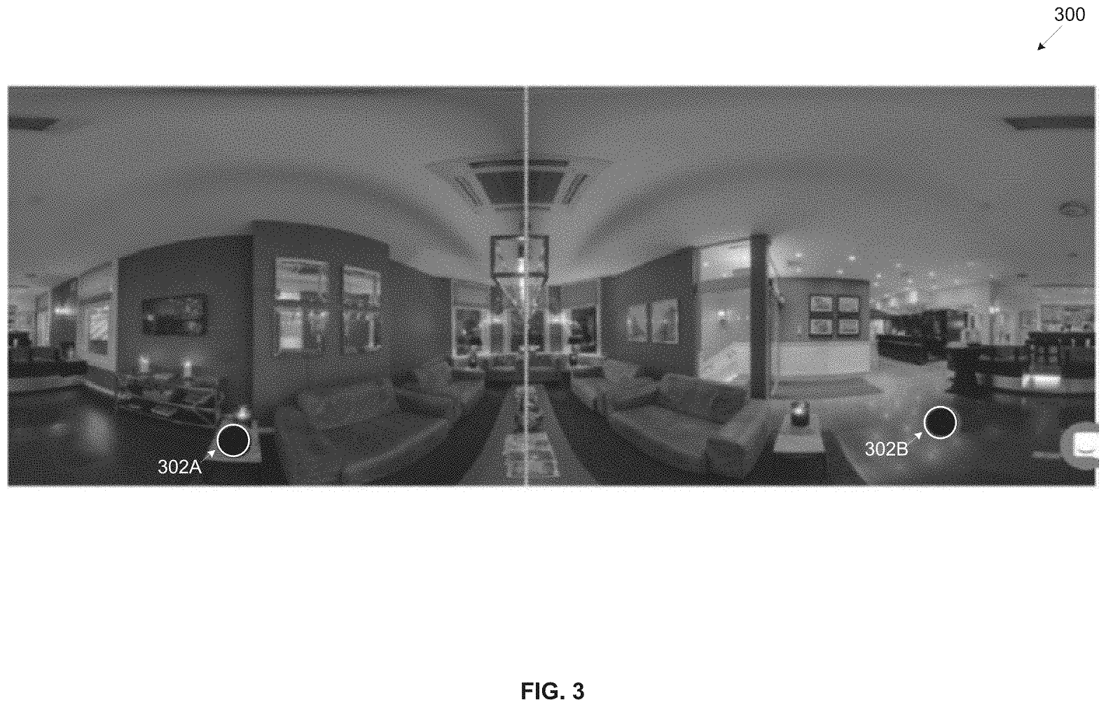

Reference is now made to FIG. 3, which is a screen capture of a VR presentation marked with presentation locations selected for embedding advertisement items presentation symbols according to a discovery difficulty level, according to some embodiments of the present invention. An exemplary VR presentation 300 of a VR environment hosted at least partially by a VR content website such as the VR content website 270 may present a hotel room may be presented to a user such as the user 250 on a VR display such as the VR display 206 controlled by a client device such as the client device 202. While the user 250 explores (navigates) the VR presentation 300, the VR content website 270 may issue an advertisement requests for two advertisement items to a campaign system such as the campaign system 204, in particular to a campaign manager such as the campaign manager 240. The campaign manager 240 may select two advertisement items for presentation to the user 250 and may further select presentation locations 302A and 302B for embedding respective presentation symbols associated with the two selected advertisement items according to the discovery difficulty level calculated for each of the selected advertisement items. The campaign manager 240 may respond to the VR content website 270 with instructions to embed the presentation symbols associated with the selected advertisement items in the selected presentation location 302A and 302B in the VR presentation 300.

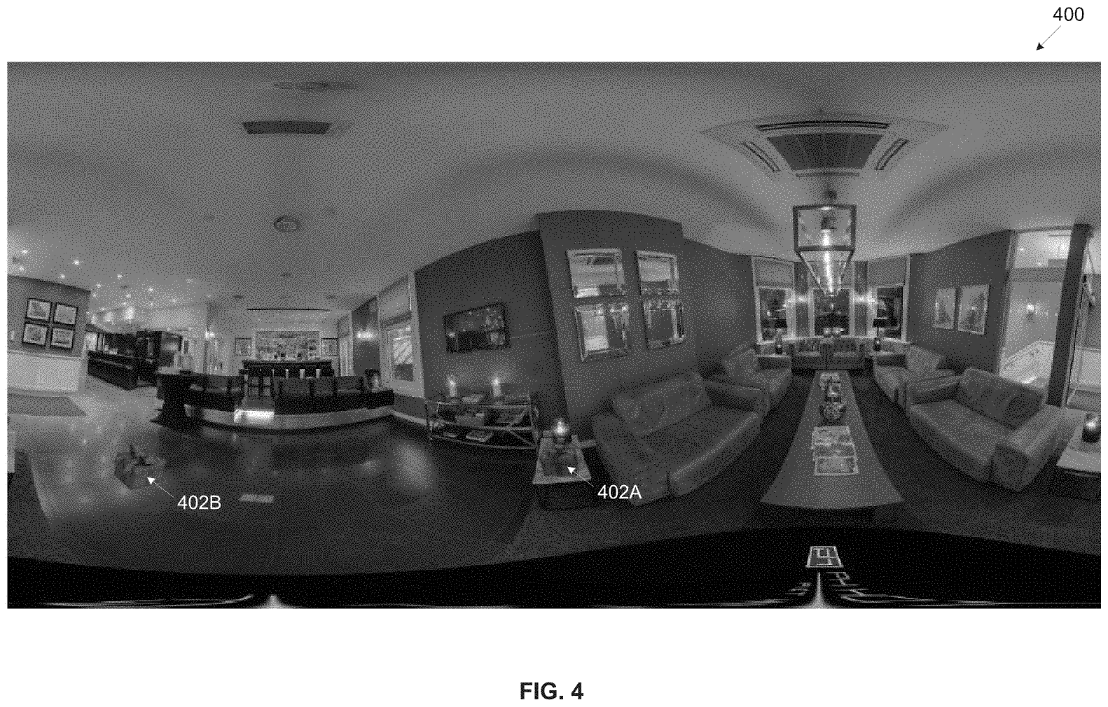

Reference is also made to FIG. 4, which is a screen capture of a VR presentation embedding advertisement items presentation symbols placed in presentation locations selected according to a discovery difficulty level, according to some embodiments of the present invention. In accordance with the instructions received from the campaign manager 240, the VR content website 270 may embed two presentation symbols 402A and 402B associated with the selected advertisement items in the selected presentation locations 302A and 302B accordingly.

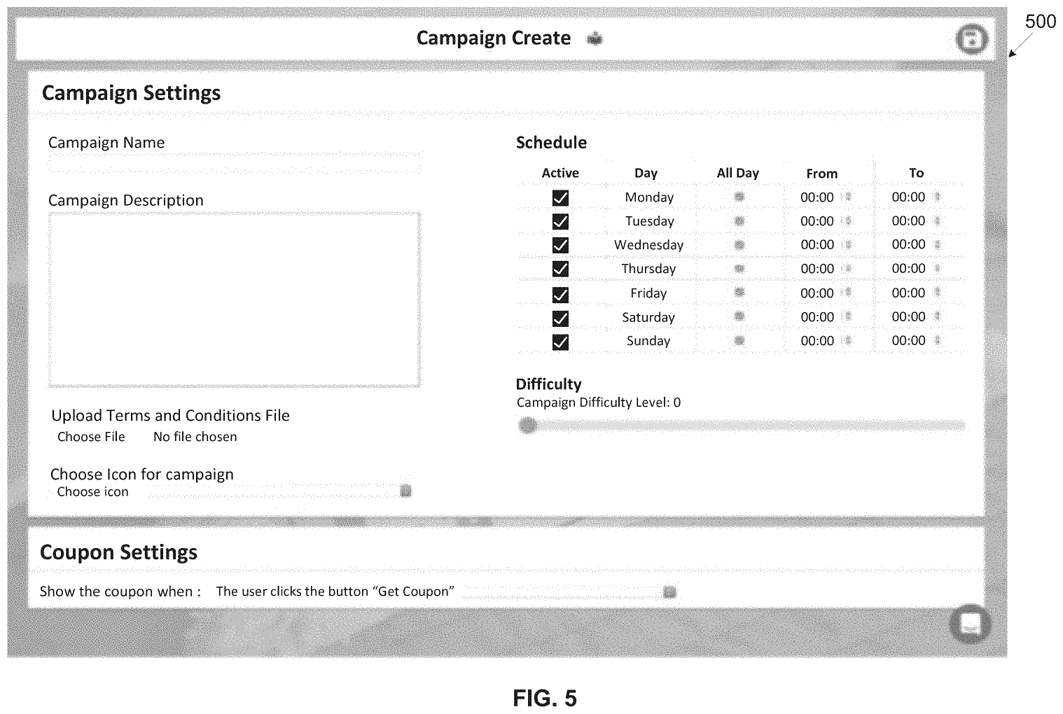

Reference is now made to FIG. 5, which is a screen capture of a User Interface (UI) of an exemplary campaign management application, according to some embodiments of the present invention. An exemplary screen capture 500 portrays a UI of an exemplary campaign management application such as the campaign manager 240. The UI screen 500 may be used by one or more campaign managers, campaign architects, campaign administrators and/or the like collectively referred to as campaign user herein after to defined one or more of the campaign rules in the campaign policy associated with one or more VR content websites such as the VR content website 270. For example, the UI screen 500 may allow the campaign user to set a schedule, for example, day, time, etc. for the expanding online campaign assigned to the VR content website 270. In another example, the UI screen 500 may allow the campaign user to define the advertisement items available for the VR content website 270. In another example, the UI screen 500 may allow the campaign user to set the discovery difficulty level for one or more of the advertisement items available for the VR content website 270.

It is expected that during the life of a patent maturing from this application many relevant systems, methods and computer programs will be developed and the scope of the terms VR user interface and VR display are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A computer implemented method of dynamically expanding an online advertisement campaign in a virtual reality (VR) environment, comprising:
using at least one processor of a campaign management system for:
receiving an advertisement request from a web site loaded by a client device for VR presentation a VR environment on a VR display to a user using a VR user interface to navigate in the VR presentation, the advertisement request comprises a request to present an advertisement item to the user currently presented with at least a portion of a certain page of the website;
selecting a presentation location in the certain page for embedding a presentation symbol correlated with a selected advertisement item, the presentation location is selected to make the presentation symbol discoverable by the user according to a discovery difficulty level calculated based on at least one of a plurality of campaign parameters defined by at least one campaign rule extracted from a campaign policy associated with the website; and
responding to the advertisement request with an instruction to embed the presentation symbol in the presentation location.

2. The method of claim 1, wherein the VR presentation is a member of a group consisting of: a VR presentation, an Augmented Reality (AR) presentation, a VR 360 presentation and an X Reality (XR) presentation.

3. The method of claim 1, wherein the selected advertisement item is a coupon entitling a holder of the coupon to at least one member of a group consisting of: a gift product, a discount in a product price, a gift service, a discount in a service price and a contest entry right.

4. The method of claim 1, wherein the selected advertisement item is selected according to the at least one campaign rule.

5. The method of claim 1, wherein the at least one campaign rule defines calculating the discovery difficulty level based on a maximum number of advertisement items available for the website.

6. The method of claim 1, wherein the at least one campaign rule defines calculating the discovery difficulty level based on a maximum number of presentation locations available in the website.

7. The method of claim 1, wherein the at least one campaign rule defines calculating the discovery difficulty level based on a maximum number of pages in the website.

8. The method of claim 1, wherein the at least one campaign rule defines calculating the discovery difficulty level based on a number of pages in the website previously traversed by the user.

9. The method of claim 1, wherein the at least one campaign rule defines calculating the discovery difficulty level based on a number of presentation symbols previously discovered by the user.

10. The method of claim 1, wherein the at least one campaign rule defines calculating the discovery difficulty level based on a user count of a plurality of users who visited the website.

11. The method of claim 1, wherein the at least one campaign rule defines calculating the discovery difficulty level based on an average user time calculated by aggregating a visit duration of a plurality of users who visited the website.

12. The method of claim 1, wherein the at least one campaign rule defines calculating the discovery difficulty level based on at least one user attribute identified for the user.

13. The method of claim 1, wherein the at least one campaign rule defines calculating the discovery difficulty level based on a discovery probability score calculated to estimate a probability that the user will discover the presentation symbol presented to the user by the client device.

14. The method of claim 1, wherein the at least one campaign rule defines calculating the discovery difficulty level based on aggregation of at least some of the plurality of campaign parameters.

15. The method of claim 1, further comprising responding to at least one subsequent advertisement request received from the website to provide at least one another advertisement item with an instruction to embed another presentation symbol correlated with at least one another selected advertisement item in another presentation location in the VR environment, the another presentation location is selected according to the discovery difficulty level calculated for the at least one another selected advertisement item based on the at least one campaign rule.

16. A system for dynamically expanding an online advertisement campaign in a virtual reality (VR) environment, comprising:
a communication interface adapted communicate with website presenting a VR presentation of a VR environment; and
at least one processor coupled to the communication interface, the at least one processor is adapted to execute a code, the code comprising:
code instructions to receive an advertisement request from the website loaded by a client device for VR presentation on a VR display to a user using a VR user interface to navigate in the VR presentation, the advertisement request comprises a request to present at least one advertisement item to the user currently presented with at least a portion of a certain page of the website,
code instructions to select a presentation location in the certain page for embedding a presentation symbol correlated with a selected advertisement item, the presentation location is selected to make the presentation symbol discoverable by the user according to a discovery difficulty level calculated based on at least one of a plurality of campaign parameters defined by at least one campaign rule extracted from a campaign policy associated with the website, and
code instructions to respond to the advertisement request with an instruction to embed the presentation symbol in the presentation location.

17. The system of claim 16, wherein the VR user interface comprises at least one wearable inertial sensor adapted to capture movement of at least one of: a head of the user and a hand of the user, wherein the user navigates in the VR presentation by initiating the movement which is translated to VR navigation instructions identified by analyzing sensory data obtained from one or more of the inertial sensors.

18. The system of claim 16, wherein the VR user interface comprises at least one inertial sensor adapted to capture movement of a client device used by the user, wherein the user navigates in the VR presentation by moving the client device which is translated to VR navigation instructions identified by analyzing sensory data obtained from one or more of the inertial sensors.

19. The system of claim 16, wherein the VR display is a member of a group consisting of: a head mounted VR display worn by the user and a flat display of a client device used by the user.

20. The system of claim 16, wherein the at least one processor is integrated in the client device, the client device comprising at least one communication interface to communicate with the VR display.
